(19) United States
(12) Patent Application Publication
(10) Pub. No.: US 2002/0123923 A1
(43) Pub. Date: Sep. 5, 2002

(54) Method and system for assessing intrinsic customer value

(76) Inventors: Stefanos Manganaris, Durham, NC (US); James R. Kraemer, Dallas, TX (US)

Correspondence Address: Mark D. Simpson, Esquire, Synnestvedt & Lechner, 2600 Aramark Tower, 1101 Market Street, Philadelphia, PA, 19107-2950, US

(21) Appl. No.: 09/798,833

(22) Filed: Mar. 1, 2001

(51) Int. Cl. G06F 17/60

(52) U.S. Cl. 705/10

(57) ABSTRACT

A method and system for assessing the potential for change in the value of a customer introduces the notion of “intrinsic customer value” (ICV) of a customer or a particular group of customers sharing similar characteristics. The ICV can be used in conjunction with the customer's actual historic value to assess the potential for change and to assist in the development of appropriate customer management plans. In particular data mining techniques are used to analyze historic customer data to determine factors that influence the expected value of a customer. Based on these findings, customer segments with distinct characteristics and estimates of intrinsic value are identified. Knowing the ICV allows businesses to make more informed decisions about marketing strategies and tactical customer management plans, and better forecast their effects.

### BACKGROUND OF THE INVENTION

1. Field of the Invention

The present invention relates to methods for conducting customer relationship marketing and more particularly to a business process for assessing the value of a business relationship with a particular customer or customer type.

2. Description of Related Art

Sound marketing strategies depend on businesses understanding their customers' value, and various methods of coming to this understanding have been practiced over the years. The current trend is to view customers as investment instruments, where the value of a customer is related to how much the customer spends and how many resources a company expends to keep and maintain that customer according to a customer management plan. Businesses traditionally measure the value of their customers by looking at their historical behavior and determining how much the business both spent and took in for a specified time period. While this is a good starting point, it is hardly substantial or complete, mainly since it fails to consider the potential for changes in the revenue or profit generated by a customer.

Data mining is a well known technology used to discover patterns and relationships in data. Data mining involves the application of advanced statistical analysis and modeling techniques to the data to find useful patterns and relationships. The resulting patterns and relationships are used in many applications in business to guide business actions and to make predictions helpful in planning future business actions. While useful in business planning, data mining has not been used to assess potential changes in the value of a customer. Accordingly, it would be desirable to have a system and method which utilizes the benefits of data mining to assess such potential changes.

### SUMMARY OF THE INVENTION

The present invention relates to a method and system for assessing the potential for change in the value of a customer. It introduces the notion of “intrinsic customer value” (ICV) of a customer or a particular group of customers sharing similar characteristics, so that this ICV can be used in conjunction with the customer's actual historic value to assess the potential for change and to assist in the development of appropriate customer management plans. In particular, in accordance with the present invention, data mining techniques are used to analyze historic customer data to determine factors that influence the expected value of a customer. Based on these findings, customer segments with distinct characteristics and estimates of intrinsic value are identified. Knowing the ICV allows businesses to make more informed decisions about marketing strategies and tactical customer management plans, and better forecast their effects.

In a first embodiment, the present invention is a method for assessing potential marketing action to be taken by a business with respect to a customer-of interest in a set of customers, comprising the steps of: (a) identifying a historical customer value (HCV) for the customer of interest; (b) computing the intrinsic customer value (ICV) of the customer-of-interest based on the HCV of the customers from the set of customers that are similar to the customer of interest; (c) comparing the HCV and ICV of the customer of interest to develop a comparison result; and (d) identifying marketing steps to be taken with respect to the customer-of-interest based on the comparison result. Step (b) of this embodiment can further comprise at least the steps of: identifying customer data pertaining to the set of customers; identifying customer attributes from the customer data and classifying the customers in the set of customers according to the attributes; establishing an expected HCV for customers in the set of customers by modeling the actual HCV in terms of relevant customer attributes; segmenting the set of customers into segments based on the customer attributes and the expected HCV; and for each customer in each customer segment, assigning the expected HCV as their ICV.

In a second embodiment, the present invention is a method for assessing intrinsic customer value (ICV) with respect to a customer-of-interest in a set of customers, comprising the steps of: (a) identifying a historical customer value (HCV) for the customer of interest; (b) computing the intrinsic customer value (ICV) of the customer-of-interest based on the HCV of the customers from the set of customers that are similar to the customer of interest; (c) comparing the HCV and ICV of the customer of interest to develop a comparison result; and (d) assessing the ICV of the customer-of-interest based on the comparison result. Step (b) of this embodiment can further comprise at least the steps of: identifying customer data pertaining to the set of customers; identifying customer attributes from the customer data and classifying the customers in the set of customers according to the attributes; establishing an expected HCV for customers in the set of customers by modeling the actual HCV in terms of relevant customer attributes; segmenting the set of customers into segments based on the customer attributes and the expected HCV; and for each customer in each customer segment, assigning the expected HCV as their ICV

### BRIEF DESCRIPTION OF THE DRAWINGS

FIG. 1 is a graph that illustrates the notion of intrinsic value in accordance with the present invention;

FIG. 2 is a graph that illustrates a comparison of the historical customer values and intrinsic customer values of three hypothetical customers, in accordance with the present invention;

FIG. 3 illustrates the division of an existing hypothetical market into four segments based on the historical and intrinsic customer values of the customers in the selected “universe” of customers, in accordance with the present invention; and

FIG. 4 is a flowchart illustrating an example of steps that can be performed to achieve the present invention.

### DETAILED DESCRIPTION OF THE PREFERRED EMBODIMENTS

The term “Intrinsic Customer Value” as used herein is defined as a particular customer's (or group of customers with the same or similar characteristics) expected value based on the historical value of other similar customers. In most cases, the term “value” refers to the monetary value of the customer: how much revenue or gross profit will be generated from the customer. However, it is understood that there are other values of a customer other than monetary value, e.g., the risk of losing a customer to the competition, and it is not intended to limit the scope of this invention to determination of the monetary value of a customer to the exclusion of any other value.

In the following discussion, the concept of ICV and of the present invention generally is discussed in connection with the gaming industry. It is not intended to limit the application of the present invention to the gaming industry, however, and it is understood that the present invention will find application in any field in which the characteristics of customers can be mined, categorized, and analyzed.

For this example, assume that a particular casino wishes to estimate the monetary value of its current customers. In accordance with the present invention this estimation is made based on the customers' demographic and psychographic data, e.g., lifestyle indicators, such as an interest in wines, boating/sailing, antiques, etc., based on magazine subscriptions, survey responses, and other sources, and attributes of their historical behavior as players at the casino. Further, in accordance with the present invention, the analysis goes beyond a customer's historical spending by taking into account other customer characteristics and the historical spending of other casino players that are similar in relevant attributes.

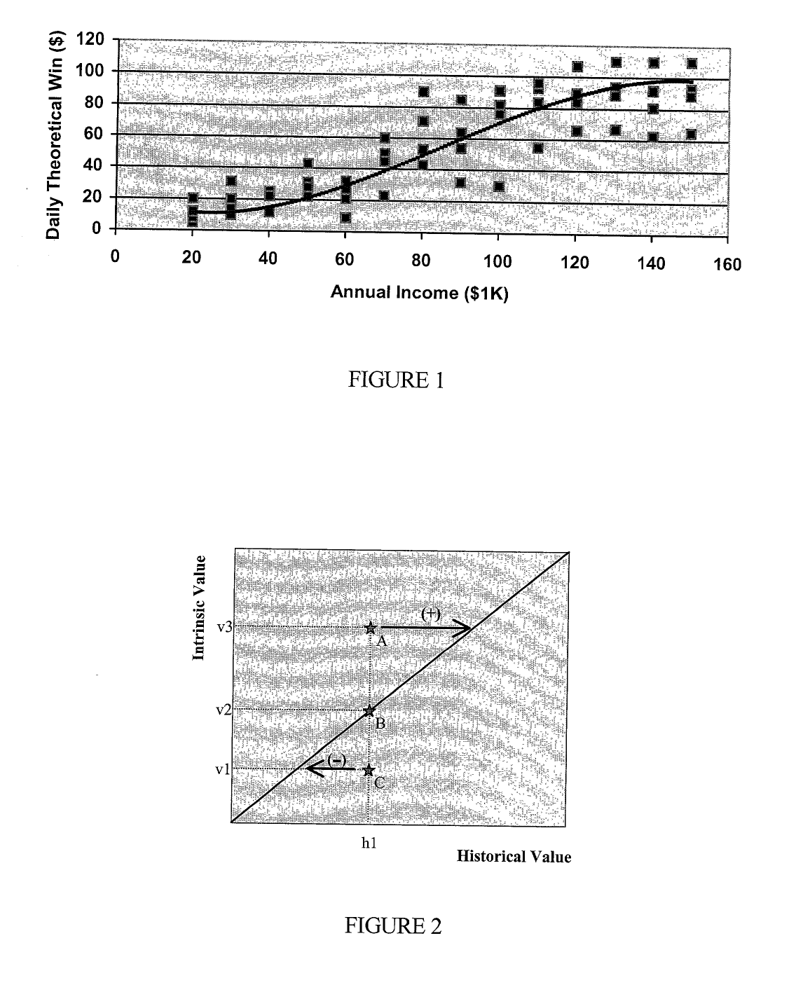

FIG. 1 illustrates the notion of intrinsic value. A measure of spending in the gaming industry is the daily theoretical win (the daily amount of money on average the casino expects to win from the customer, taking into account not only the amounts bet but also the odds of the customer winning and the casino's corresponding payout obligations). Each point on the graph represents a hypothetical customer. This graph shows the relationship between a hypothetical customer's annual income and their historical daily “theoretical win”. As can be seen, as income rises, spending also rises. Moreover, the variability in spending grows larger with income as well. At any given income level, there is a segment of customers, similar in terms of annual income, with a range of values for their theoretical win. The expected theoretical win is plotted with a dotted line as a function of annual income.

For any given customer, given this information, an intrinsic value can be assigned that denotes the expected level of spending based on income and the historical behavior of other similar customers. In real-world applications, the customers would be described and categorizable using hundreds of attributes. Following well-known data mining practices, one would have to determine what constitutes segments of similar customers, and what is the expected theoretical win for a customer.

The customer's intrinsic value is important because it acts as a reference point for comparison to a customer's historical value. FIG. 2 shows the results of the comparison. Three hypothetical customers (Customers A, B, and C) have an identical historical value of hi; as an example, in the context of gambling hi could represent $10,000 per year of spending at a particular casino. As can be seen in FIG. 2, the historical value of customer A is below his intrinsic value, while the reverse is true for customer C. Customer B is at her intrinsic value. In other words, Customer A is spending below his “potential”, Customer B is spending at her potential, and Customer C is spending above his potential. Because the intrinsic value is the expected value (by definition), the three customers are profoundly different even though they appear identical from a historical perspective. A marketing strategy that attempts to increase customer spending will likely succeed more for customer A than C, because most other customers similar to A already have higher spending. In a sense, there is a natural tendency for customers to change their actual historic value to match their intrinsic value. In FIG. 2, this tendency for customers A and C is marked with arrows denoting a propensity force that drives customers toward the diagonal.

Businesses can forecast the effects of their marketing strategies by taking into account the location of a customer in the space of actual historic vs. intrinsic customer value. Moreover, taking this location of customers into account can help in the design of more effective marketing strategies. For example, for customer C a strategy designed to maintain the status quo may be more effective than a strategy to stimulate spending increases because most customers like C have had historicaly a lower actual level of spending.

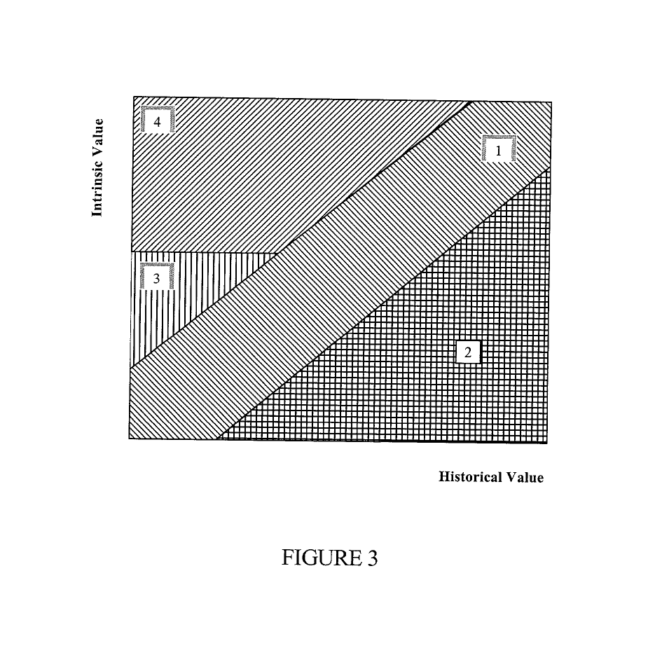

FIG. 3 shows an example in which the existing market has been divided into four segments based on the historical and intrinsic customer value. Segment 1 appears fairly homogenous with little, if any, deviations between actual and intrinsic customer values. No customers stand out as obvious under- or over-performers compared to their peers. Customers close to their intrinsic value (Segment 1) may best respond to a strategy designed to gradually raise the spending of the whole segment and thus the intrinsic values themselves. Segment 2 consists of over-performers, customers for which it appears the business has captured a higher than expected share of their wallet. Segment 2 would benefit most from a maintenance, reward, and retention strategy, while segments 3 and especially 4 would be appropriate for an aggressive customer-focused expansion or reacquisition strategy. Segments 3 and 4 consist of under-performers, with those in segment 4 being the most highly valued because they have the most room for improvement.

In real-world applications (as opposed to the simplified example above), businesses would devise a segmentation scheme that includes additional customer dimensions, such as recency of last purchase, geographic location of residence, and others, and would use common marketing tools to implement the appropriate strategies. By considering more customer attributes, one can achieve finer-grain segmentations, with more specific descriptions of customer profiles that can facilitate the development of appropriate relationship management strategies. For example, the segment of underperformers may be broken into two, a subsegment for customers with lifestyle dimensions and needs aligned to the business and another for the remaining customers. The first segment may be underperforming because it has fallen prey to competitors and may be much more amenable to a win-back strategy than the second, which appears indifferent to the products and/or services.

Data-mining techniques can help compute the intrinsic value of customers. Under the umbrella of data mining, a set of techniques addresses what are known in the field as regression and segmentation problems. Regression techniques help induce predictive models from historical data. These models predict a numeric value for a variable (called the response or dependent variable) given some input of values for another set of variables (the predictors or independent variables). A good model predicts values that are close to the actual values of the response variable not only for the data used to build the model, but also for other data from the same domain that was not used for model building. In other words, a good model predicts the expected value for the response variable for any given input.

Modern regression techniques can select relevant predictors for inclusion in the model. Further, they can induce from the data complex relationships between the predictors and the response variable, and encode them into an accurate and informative model.

Programs that perform such regression techniques are known in the art. For example, IBM's “DB2 Intelligent Miner” includes several excellent regression and segmentation tools, each with its strengths and limitations. One data mining kernel builds regression models using neural networks, which are particularly appropriate when complex, nonlinear relationships between the predictors and the response variable exist. Another kernel uses a class of mathematical formulas, called radial-basis functions, to express the models. One useful feature of this kernel is its ability to show the characteristics of various segments associated with different values for the response variable. Yet another kernel builds regression models as decision trees. Such models are self-explanatory: All predictions are made by answering a series of yes/no questions. All kernels can take advantage of parallel hardware, such as IBM SP machines, to analyze big data sets consisting of large numbers of data points (database records) and variables (database columns), reveal hidden relationships, and produce accurate models, segments, and segment profiles.

To compute ICV's, businesses can employ any regression technique to model the historical value of customers. The set of predictors will vary from application to application and from industry to industry, but in general businesses should include variables that describe the customer (such as demographic and psychographic characteristics) and the customer's behavior (such as historical product preferences). Using the historical value as the response variable will result in a model that predicts the expected historical value for any given customer based on the values of similar customers, which is the ICV by definition. In general, the model will use a subset of the predictors-those that appear to be relevant for the estimation of a customer's ICV. These selected variables distinguish customers that belong in different segments associated with different ranges of intrinsic values. Businesses can profile these segments by examining the distribution of values for the selected variables within the segment and across segments. The differences show the various factors influencing customer value, which often can illuminate the underlying customer dynamics and suggest ways to change them.

The following examples of customer attributes and/or categorization of customer data are given for the purpose of example only. Virtually any statistical data regarding customers and the habits thereof may be utilized in connection with the calculation of the ICV. For example, various aggregate measures to characterize the behavior of customers may be derived in relation to the business seeking to determine the ICV. Such measures may include the quantity of events, the sums of quantities (e.g., amount in dollars), mean and median of quantities, minima and maxima of quantities, standard deviations around the mean, ratios of quantities that can be distributed in categories (e.g., in relation to gaming, time spent playing pit games, theoretical wins occurring during pit games, the amount of hotel revenues per particular room types, etc.).

Regarding analysis of particular customers, the following attributes might be considered: personal (customer age, gender, occupation, occupation of spouse, etc.); household (marital status, presence of working woman in household, presence of children, number of adults in household, possession of various types of credit cards, estimated income); real property (homeowner/renter, length of residence, dwelling size); purchase behavior (mail order buyer, mail responder); auto data (truck/motorcycle/RV owner, aggregate number of vehicles owned, new car buyer indicator, number of vehicles owned, dominant vehicle lifestyle indicator); wealth indicators (net worth, income producing assets); lifestyle dimensions (this could be a list of hundreds of life traits for an individual, such as casino gambling, state lottery player, foreign traveler, wine drinker, etc.); historical product mix (proportion of time in various hotel room types, portion of time/revenue in various pit games); historical gaming behavior (tenure with a particular casino, average pit game elapsed time per day); historical event triggers (number of jackpots, win/loss ratio, etc.); and historical visit behavior (average, minimum, maximum time between visits, variants in time between visits, average days per visit, tenure, total number of days at particular casino, total number of visits, etc.).

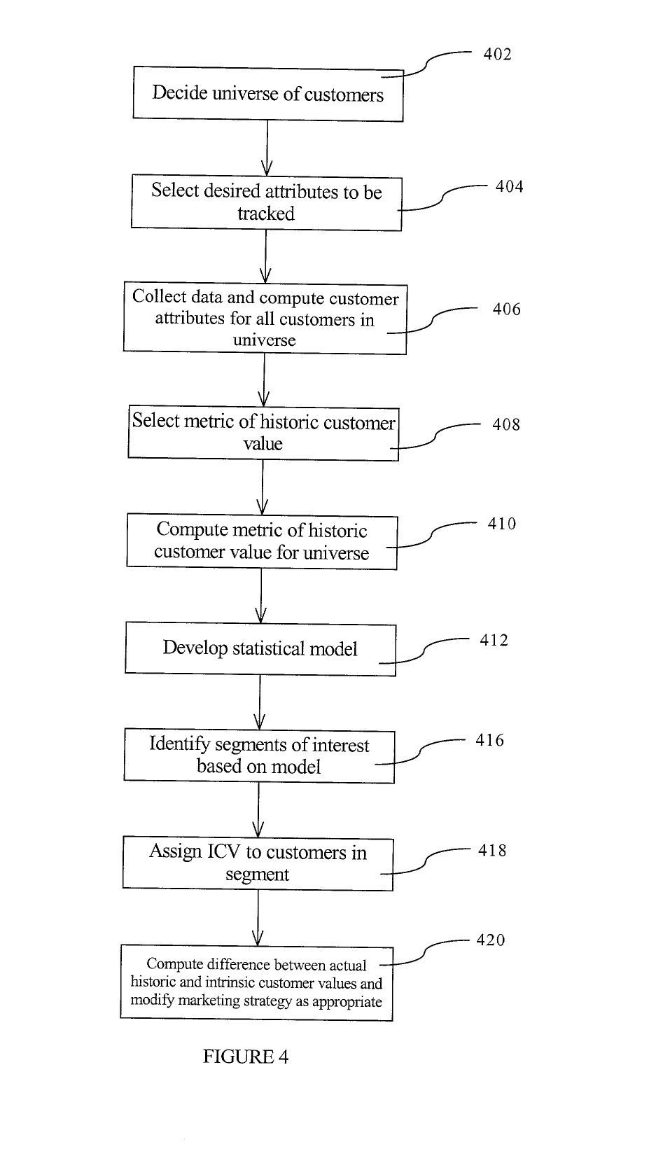

FIG. 4 is a flowchart illustrating an example of steps to be performed in accordance with the present invention. At step 402 a decision is made regarding the definition of the universe of customers from which data will be mined. This could include just customers of a particular casino, customers from all casinos affiliated with a particular chain, all customers for all casinos for which data is available, etc. Next, at step 404, the desired attributes of the customers in the universe are identified, e.g., customer attributes that capture demographic, psychographic, and behavioral characteristics.

At step 406, data is collected for the customers in the universe and customer characteristics, derived from the attributes found in the data, are calculated for the customers in the universe.

At step 408, the metric of historic customer value (e.g., revenue per year; revenue per quarter; profits vs. revenues; etc.) is selected. At step 410, the metric of historic customer value for each customer in the universe is determined by analyzing the customer's historical data.

At step 412, a statistical model is developed for the metric of historic customer value in terms of customer attributes.

At step 414, the customer universe is partitioned into segments with distinct characteristics and expected levels of historic customer value as predicted by the statistical model. At step 416, each customer in each segment is assigned the expected historic customer value, as the customer's ICV. This step actually characterizes each member of the particular segment as having the same ICV.

At step 418, the different between the actual historic customer value and the ICV is computed, and based upon the result of this computation (as described above), the marketing strategy for the particular customer may be modified, if appropriate, to best exploit this computed information.

An example of the use of the present invention with respect to three hypothetical customers of “Lynn's LasVegas Freewheeler Casino” (“Lynn's”), a hypothetical gaming establishment, illustrates the methodology and benefits of the present invention. For purposes of the example, a small set of attributes is utilized for the sake of simplicity. Specifically, in this example, the attributes are estimated annual income, gender, age, local vs. non-local market, repeat vs. first-time visitor, and slot vs. pit gaming history.

Customer No. 1, David, is male, living locally to the casino, 65 years old, with an annual income of $40,000 and a history of repeat visits to Lynn's, where he primarily plays pit games. Customer No. 2, Timothy, is male, non-local, 35 years old, with an annual income of $85,000 and a history of repeat visits to Lynn's, also primarily playing pit games. Finally, customer No. 3, Claire, is female, local, 52 years old, with an annual income of $32,000 per year, and no history of visits to Lynn's.

Based on a review of historical data pertaining specifically to each of the three hypothetical customers, the following historical customer values are ascertained: David, customer No. 1, has a historic value to Lynn's of $1,000/quarter, since David, on average, tends to spend about $1,200 per quarter at the casino, with about $200 per quarter received from the casino in “comps” (i.e., complimentary items or services provided by the casino as incentives); Timothy, customer No. 2, has a historic value of $9,000/year, since Timothy, on average, tends to spend about $11,000 per year, with about $2,000 per year in comps and other incentives, such as paid air tickets and hotel accommodations; and Claire, customer No. 3, has a historic value of $0/quarter, since she has no history of visits to the casino.

As noted above, the historic customer values present a good starting point for marketing decision-making, but do not give a complete picture. In accordance with the present invention, by calculating the ICV, Lynn's casino has at its disposal an additional, more interesting and useful tool for marketing decision-making. Assume that the results of data mining of historical customer data for all of Lynn's customers indicates that customers with David's characteristics have a historic customer value, as a group, of $2,000/quarter. In accordance with the present invention, this value is assigned to David as his ICV. Since David's historic customer value is $1,000/quarter less than his ICV, this indicates that Lynn's marketing efforts are not capturing the full potential of David, and the marketing department should consider why this is occurring and what can be done about it. He is a local male, likely retired, middle-class customer, who is hooked on pit games, and spending less than he should/could, based on the behavior of his peers. Possibly he is spending the uncaptured potential at a competitor's casino; this could direct the marketing department to pursue a marketing strategy for growing his spending and keeping him from frequently competitor's casinos.

Suppose, instead of David having an ICV of $2,000/quarter, David has an ICV of $500/quarter. This indicates that he is spending $500 more per quarter than you would expect, based on the behavior of his peers. Since the marketing efforts being utilized seem to be working very well, a maintenance marketing strategy might be most appropriate for him. Thus, as can be seen, the marketing strategy for a customer may change drastically based upon what the ICV turns out to be.

The same type of analysis can be done for customers 2 and 3. With respect to customer No. 3, Claire, since there is no historic value upon which to base marketing strategies, the ICV (the estimated value of Claire based on similar customers) will be extremely valuable to the marketing department.

Marketing strategies must become more sophisticated. Data mining techniques let marketers focus not on how much a customer spends but on how much a customer should spend. By highlighting the effects of various factors on customer value, data mining techniques can help marketers convince customers they should do so.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A method for assessing potential marketing action to be taken by a business with respect to a customer-of-interest in a set of customers, comprising the steps of:
(a) identifying a historical customer value (HCV) for said customer of interest;
(b) computing the intrinsic customer value (ICV) of said customer-of-interest based on the HCV of said customers from said set of customers that are similar to said customer of interest;
(c) comparing said HCV and ICV of said customer of interest to develop a comparison result; and
(d) identifying marketing steps to be taken with respect to said customer-of-interest based on said comparison result.

2. A method as set forth in claim 1, wherein step (b) comprises at least the steps of:
identifying customer data pertaining to said set of customers;
identifying customer attributes from said customer data and classifying said customers in said set of customers according to said attributes;
establishing an expected HCV for customers in said set of customers by modeling the actual HCV in terms of relevant customer attributes; segmenting said set of customers into segments based on said customer attributes and said expected HCV; and
for each customer in each customer segment, assigning said expected HCV as their ICV.

3. The method of claim 2, wherein step (a) comprises at least the step of identifying an HCV metric and computing said HCV for said customer of interest based on said metric.

4. A method for assessing intrinsic customer value (ICV) with respect to a customer-of-interest in a set of customers, comprising the steps of:
(a) identifying a historical customer value (HCV) for said customer of interest;
(b) computing the ICV of said customer-of-interest based on the HCV of said customers from said set of customers that are similar to said customer of interest;
(c) comparing said HCV and ICV of said customer of interest to develop a comparison result; and
(d) assessing the ICV of said customer-of-interest based on said comparison result.

5. A method as set forth in claim 4, wherein step (b) comprises at least the steps of:
identifying customer data pertaining to said set of customers;
identifying customer attributes from said customer data and classifying said customers in said set of customers according to said attributes;
establishing an expected HCV for customers in said set of customers by modeling the actual HCV in terms of relevant customer attributes;
segmenting said set of customers into segments based on said customer attributes and said expected HCV; and
for each customer in each customer segment, assigning said expected HCV as their ICV.

6. The method of claim 5, wherein step (a) comprises at least the step of identifying an HCV metric and computing said HCV for said customer of interest based on said metric.
